(19) United States
(12) Patent Application Publication
(10) Pub. No.: US 2023/0368129 A1
(43) Pub. Date: Nov. 16, 2023

(54) UNSUPERVISED LEARNING FOR REAL-TIME DETECTION OF EVENTS OF FAR EDGE MOBILE DEVICE TRAJECTORIES

(71) Applicant: Dell Products L.P., Round Rock, TX (US)

(72) Inventors: Vinicius Michel Gottin, Rio de Janeiro (BR); Nalinkumar Mistry, Ottawa (CA); Pablo Nascimento da Silva, Niteroi (BR); Eric L. Caron, Ottawa (CA); Paulo Abelha Ferreira, Rio de Janeiro (BR)

(21) Appl. No.: 17/663,423

(22) Filed: May 14, 2022

(51) Int. Cl. G06Q 10/08; G06N 5/04; G06N 20/00

(52) U.S. Cl. CPC G06Q 10/087; G06N 5/04; G06N 20/00

(57) ABSTRACT

An event driven detection model is disclosed. A model operates at a node using data generated by sensors associated with the node to identify events. The events are provided to a model configure to infer whether the event is non-normative. When a non-normative event is inferred by the model, a decision may be made and performed.

### FIELD OF THE INVENTION

Embodiments of the present invention generally relate to logistics and event detection. More particularly, at least some embodiments of the invention relate to systems, hardware, software, computer-readable media, and methods for monitoring objects in an environment to facilitate logistics operations and for supporting decision making tasks in environments that include multiple objects.

### BACKGROUND

Logistics in environments such as a warehouse can be difficult to monitor and manage at least because many different objects in the environment may exist and/or operate simultaneously. Many of the objects in the warehouse, for example, are mobile in nature while other objects are stationary or fixed. As a result, care should be exercised to ensure that accidents or other problems do not occur. This can be difficult as many of the objects operate concurrently, and their relative positions may not be known to each other.

Many environments may include mobile devices or machines, which are examples of objects. For example, mobile devices such as forklifts may operate in a warehouse environment. Forklift operators need to look out for each other in addition to taking care around other objects or hazards such as shelving or storage space, pillars, docks, pallets, and the like. Even if these forklift operators are able to communicate with each other, it is difficult to coordinate the movement of multiple forklifts and ensure that undesirable interactions do not occur.

The movement of forklifts in an environment can lead to dangerous situations because forklifts are their movement can vary significantly. In addition to paying attention to other forklifts, forklifts may experience dangerous events without interacting with other objects. Forklifts perform various mobile maneuvers for various reasons including the layout of the warehouse, the location of product, or the like. Forklifts, if driven in an unsafe manner, may be involved in an accident. Dangerous event that may lead to problems include turning too sharply, turning while driving at an excessive speed, or turning too close to a hazard.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of models, including machine learning models, that facilitate logistics operations in environments;

FIG. 2 discloses aspects of a local model configured to generate inferences based on data generated by sensors at nodes in an edge environment;

FIG. 3A discloses aspects of a training pipeline and an inference pipeline for detecting non-normative events;

FIG. 3B discloses additional aspects of a training pipeline for training a model to detect or identify non-normative events;

FIG. 3C discloses aspects of an inference pipeline operating on a local node in an edge environment;

FIG. 3D discloses aspects of detecting non-normative events;

FIG. 3E discloses aspects of a model that is deployed to far edge nodes and configured to detect or infer non-normative events; and

FIG. 4 discloses aspects of a computing device or a computing system.

### DETAILED DESCRIPTION OF SOME EXAMPLE EMBODIMENTS

Embodiments of the present invention generally relate to logistics and event detection. More particularly, at least some embodiments of the invention relate to systems, hardware, software, computer-readable media, and methods for supporting decision making tasks in complex environments.

Embodiments of the invention can be applied or implemented to provide or perform logistics operations in different types of environments. Generally, an environment may include objects, including mobile objects, movable objects, and/or stationary or static objects. These objects may include or be associated with sensors of varying types that generate data. The data may be analyzed to detect events and/or to perform actions upon detecting an event.

The data generated by the sensors can be used to perform logistics operations, which include by way of example and not limitation, event detection operations, cornering detection operations, tracking operations, trajectory prediction operations, trajectory operations, alerting operations, positioning operations, object management operations, object monitoring operations, automation operations, safety operations, hazard detection operations, hazard avoidance operations, auditing operations, management operations, or the like or combination thereof. More specifically, embodiments of the invention perform logistics, including decision making operations, based on sensor data generated at edge nodes in an edge environment.

Embodiments of the invention may further relate to detecting cornering events, including dangerous cornering events, in the trajectories of mobile objects operating in far edge environments. Mobile objects may include, but are not limited to, autonomous mobile robots or vehicles, automatic guided vehicles, mobile machines capable of being driven/pulled/pushed/moved, and the like. Embodiments may relate to mobile devices or vehicles operating in, by way of example, manufacturing, retail, and other environments.

Embodiments of the invention are particularly discussed with respect to the operation of forklifts in a warehouse environment. Embodiments of the invention can be applied to other mobile devices, vehicles, or machines in other environments.

For example, embodiments of the invention are disclosed with respect to detecting unsafe or dangerous events such as cornering events. However, embodiments of the invention can be adapted to detect other types of specific events and/or to generating alerts and notifications. Embodiments may also perform automated operations such as generating notifications or alerts when an event is detected, cutting power to a device, or the like. Embodiments of the invention are further discussed in the context of an environment such as a warehouse.

From the perspective of a mobile device such as a forklift, for example, all other objects may constitute hazards. Hazards, as used herein, does not necessarily refer to dangerous objects. Thus, from the perspective of a specific forklift, hazards include other objects such as other forklifts, people, pallets, zones (e.g., defined areas), docks, corridors, corners, or the like or any combination thereof. Further, the definition of a hazard or object may also be dependent on the environment (or domain).

Embodiments of the invention are achieved, in part, by equipping the objects in the environment with hardware such as sensors, processors, memory, networking hardware, or the like. In some examples, the objects may already be equipped with this type of hardware or portions thereof. The hardware may depend on the nature of the associated object. Mobile objects, for example, may be equipped with a different set of sensors compared to sensors or devices associated with a stationary or movable object. For example, hardware such as sensors, processors, memory, or the like may be integrated with a forklift. A pallet, in contrast, may only have an RFID (Radio Frequency Identification) tag.

The hardware (and/or any software thereon) may be referred to as a node. However, reference to a node may also constitute a reference to the object associated with the node and on which the node is attached. Reference to an object, such as a forklift, may refer to the object and/or the node.

Nodes in the environment may be referred to as edge or far edge nodes as they operate on the edge of a network and may communicate with a central node operating at a near-edge infrastructure and/or in a datacenter. The central node is typically more computationally powerful than the edge nodes.

In one example, a node may be associated with sensors including position sensors and/or inertial sensors. The position and/or inertial sensors may generate data that allows movement to be detected, measured, or inferred. A machine learning model may be trained to detect cornering events, detect dangerous or unsafe cornering events, and/or take corrective actions such as generating alerts, notifying operations, or the like.

In some embodiments, the edge nodes may each have sufficient hardware (e.g., processor, memory, networking hardware) to process data generated by the node's sensors and/or data about other nodes that is broadcast by a central node or by the other local nodes or other objects in the environment. The central node is able to perform more complex and thorough processing of the data generated at or by nodes in the edge environment.

As previously stated, each node in the environment may be associated with one or more sensors. A forklift, for example, may be associated with a node that includes or is associated with sensors positioned at various locations on the forklift. The sensors may be placed on the forks or arm (e.g., at the distal ends) and/or on the body of the forklift. This allows the position of the forklift (and of the arms) to be determined. Other information such as height, width, and length of the forklift may also be known or determined and taken into account. However, the position data may be combined to form a single position and/or orientation of the forklift. For example, if the position is displayed on a monitor, the position of each forklift may be a short line to represent position and an arrow to represent orientation or direction. The interface may be augmented with other data such as speed, whether the forklift is turning, whether the forks are moving up/down, or the like.

The node associated with a forklift may include other sensors such as cameras, temperature sensors, velocity sensors, motion sensors, acceleration/deceleration sensors, or the like or combination thereof may also be provided. In general, the sensors associated with a forklift may generate data that can be used to detect objects, detect events or conditions, record events, determine a position/orientation/direction/trajectory of the forklift in the warehouse (or its vicinity), velocity, direction of travel, or the like. The sensor data may be processed at the node and/or at the central node to detect/identify objects and events, determine a position of the forklift and/or predict a trajectory of the forklift and/or perform localized decision-making operations.

Movable objects such as pallets or products may be associated with a node that includes RFID tags such that the positions of objects such as pallets can be read and tracked in the environment. Personal cellular phones may be used to track the positions/movement of people in the environment. The locations of other objects such as docks, corridors, or the like does not change and is known or programmed into the edge nodes and/or the central node that are performing logistics operations.

The warehouse is an example of an edge environment in which quickness and accuracy in decision making (including safety related decisions) is useful. Embodiments of the invention may detect objects, enable real-time object aware event detection, detect cornering events, or the like. Data originating at the nodes is collected from the nodes and processed using computing resources of the node. Each node, for example, may have a local model configured to generate inferences from locally generated sensor data. Data from all nodes may be received by a central node (e.g., container(s), physical machine(s), server(s), virtual machine(s)) operating at a near-edge infrastructure (or the cloud) and processed using resources of the near-edge infrastructure (or cloud).

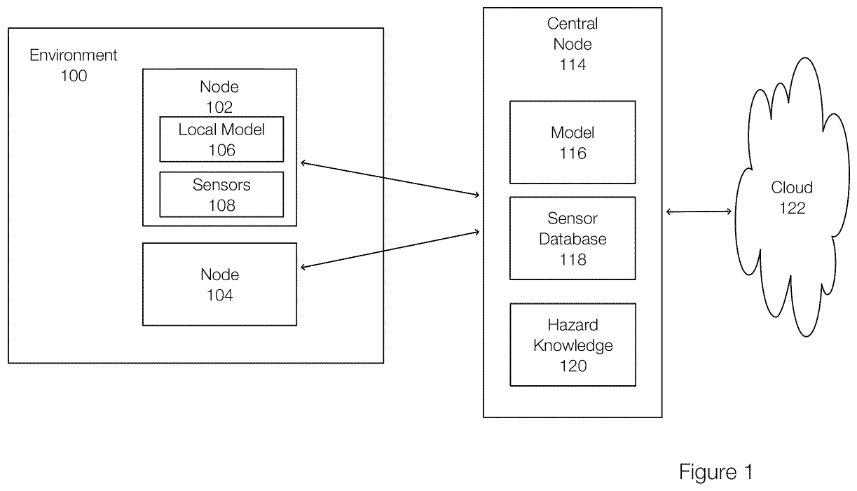

FIG. 1 discloses aspects of an environment in which embodiments of the invention may be deployed or implemented. FIG. 1 illustrates a system (e.g., a logistics system) that includes edge nodes, represented by nodes 102 and 104 (e.g., forklifts), and a central node 114. The edge nodes and the central node may coordinate to perform logistics operations.

The environment 100 may be a warehouse or other environment. The nodes 102 and 104 operate or exist in the environment 100. In the context of a warehouse environment, the nodes 102 and 104 may have different types and correspond to or are associated with objects related to the warehouse environment. In the present example the nodes 102 and 104 may correspond to or are associated with forklifts or other mobile device, vehicles, machines, etc. The nodes 102 and 104 may operate the environment 100, which may also be associated with other objects (e.g., machinery, hazards, persons, corridors, corners, shelving) that may be mobile, movable, or stationary and which are hazards from the perspective of the nodes 102 and 104.

Each of the nodes 102 and 104 may be associated with or include sensors. The sensors may depend on the associated object. Example sensors include position sensors (at least one), and inertial sensors (at least one). The nodes 102 and 104 may include compute resources such as a processor, memory, networking hardware, or the like.

A central node 114 (e.g., implemented in a near edge infrastructure or in the cloud) may be configured to communicate with each of the nodes 102 and 104. The communication may be performed using radio devices through hardware such as a router or gateway or other devices. Depending on the sensors and the configuration of the node, the communication may be one way. For example, a pallet associated with an RFID tag may simply be read to determine the pallet's position. The nodes 102 and 104, in contrast, may also receive information from the central node 114 and use the information to perform various operations including logistics operations.

For example, the node 102, which may be attached to or be an integral part of an object such as forklift, may be configured with sensors 108 of various types and with sufficient hardware (e.g., processor, memory) to implement and run a local model 106 using the data collected or generated by the sensors 108 of the node 102. Other nodes in the environment may also include or be associated with a local model.

For example, if the node 102 corresponds to or is associated with a forklift, the sensors of the node 102 may be arranged on the forklift in different manners. For example, position sensors may be deployed on the forklift's arms (forks or tines). By placing sensors on the arms, the positions of the arms relative to the forklift body and in the environment 100 can be determined. Alternatively, the node 102 may be associated with a single position sensor. In one example, the sensors 108 of the node 102 allow a center position of the node to be determined. The position sensors generate positional data that determine a position of the forklift in the environment 100. Positional data can also be collected as time series data, which can be analyzed to determine a position of the forklift, a velocity of the forklift, a trajectory or direction or travel, that the forklift is turning or cornering, or the like. The sensors 108 may also include inertial sensors that allow acceleration and deceleration to be detected in multiple directions.

In one example, a map of the environment is generated and may be stored at the central node 114 and/or at the edge nodes. The system may be configured to map the position data received from the nodes into a map of the environment. This allows the positions of all nodes (objects) to be determined with respect to each other and with respect to the environment 100.

The central node 114 may include a near edge model 116 and a sensor database 118. The sensor database 118 may be configured to store sensor data received from the nodes 102 and 104 and/or other nodes in the environment 100. Because the nodes are associated with or integrated with objects, the sensor database 118 stores information about the objects in the environment 100. More specifically, the sensor database 118 may be used to store the information generated by or at the forklifts (the nodes 102 and 104). The sensor database 118 may include a database for different sensor types. Thus, the sensor database 118 may include a position data database, an inertial database, and the like. In another example, the sensor database 118 may store all sensor data together and/or in a correlated form such that position data can be correlated to inertial data at least with respect to individual nodes and or in time.

The hazard knowledge 120 includes information relative to the hazards in the environment 100. The hazards represent relevant aspects of the operational area or environment 100, which may include movable and/or static objects. In one example, a defined area may also constitute a hazard.

By way of example only, the local model 106 may generate an alarm or notification based on the data from the sensors 108. The model 116 may also be configured to generate an alarm based on the data from the sensors 108 and or data from sensors associated with other nodes in the environment 100. The model 106 may also generate an alarm or notification based on communications from the central node 114.

In one example, the local model 106 is trained at the central node 114 and/or the cloud 122 and deployed to the relevant nodes 102 and 104. The local model 106 is trained using available (historical) positioning and/or inertial measurement data (and/or other sensor data, which may include video data). Different models may be used for different data types. After training, the local model 106 may be deployed to the nodes. In one example, the model 116 and the local model 106 are the same. One difference is that the local model 106 may operate using locally generated data at the node 102 as input while the model 116 may use data generated from multiple nodes in the environment 100 as input.

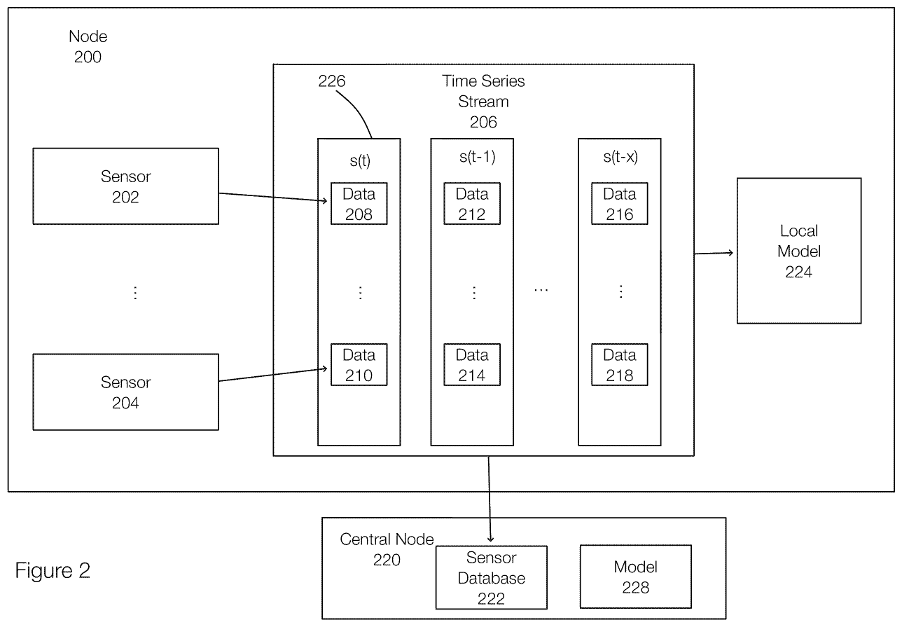

FIG. 2 discloses aspects of a node associated with or integrated with an object and configured to operate in an environment and perform logistics operations. The node 200, an example of the node 102, may include sensors, represented by sensors 202 and 204. In this example, the sensors 202 and 204 may include position sensors and/or inertial sensors.

The node 200 collects, over time, multiple readings from the sensors 202 and 204. The data generated by the sensors 202 and 204 may constitute a time series stream 206. For example, the stream 206 includes readings at different times and the data collected at a particular time may be referred to as a collection. Thus, the time series stream 206 may include multiple collections such as the collection 226.

The data 208 and 210 in the collection 226 were collected at time s(t), the data 212 and 214 were collected at time s(t−1), and the data 216 and 218 were collected at time s(t−x). Each of the nodes that includes sensors may generate a similar sensor data stream. Data generated from the sensors 202 and 204 may be collected periodically, whenever a change in a sensor's data is detected (e.g., acceleration or deceleration is detected), or the like or combination thereof. Data from the sensors 202 and 204 may be collected at different times. Further, the sensors 202 and 204 may be grouped by type (e.g., position sensors, acceleration sensors, temperature sensors) and each data from each type or from designated groups of sensors may be collected separately. In one example, there may be a time series stream for positional data, a time series stream for inertial data, or the like. Further, time series streams may be coordinated in time. A collection of inertial data may correspond to a collection of position data.

The data collected from the sensors 202 and 204 is associated with or includes position data that can be mapped into coordinates of the environment 100. Thus, for the collection of data associated with time s(t), a position p(t) is associated with the collection 226 of data. When collecting data from the sensors 202 and 204, the collection of data is typically correlated to a position in the environment. In addition to position data, sensors may also provide inertial measurements of acceleration and deceleration. Other data, for objects such as a forklift, may include mast position, load weight, or the like. The data collected from an object may depend on the object.

The time series stream 206 may be transmitted to a central node 220, an example of the central node 114, and stored in a sensor database 222 of or associated with a central node 220. Thus, the time series stream 206 is available for use by the local model 224 to generate inferences, such as whether an event is occurring/has occurred. The time series data from all nodes is available to the near edge model 228, which may perform the same or similar function as the local model 224 but may generate inferences based on data from multiple nodes.

The time series stream 206 may be collected periodically at the central node 220. This allows the central node 220 to store sensor data from each of the nodes in the sensor database 222. The central node 220 may store position/inertial data related to both dynamic and static nodes.

When detecting events such as cornering events, data including position data and inertial data (generally referred to as positional or position data) may be collected. The position or positioning data may include GPS (Global Positioning System) data, RFID (Radio Frequency Identification) or WiFi triangulation data, or combination thereof. The inertial data may include inertial measurements of acceleration and deceleration. The inertial data may be obtained via inertial measurement unit (IMU) sensors. The positional data is used to detect cornering events. More specifically, embodiments of the invention focus on aspects of the positional data that represent cornering. However, embodiments of the invention can be adapted to detect other events that are represented by the positional data or from other sensors that may correspond to other types of events.

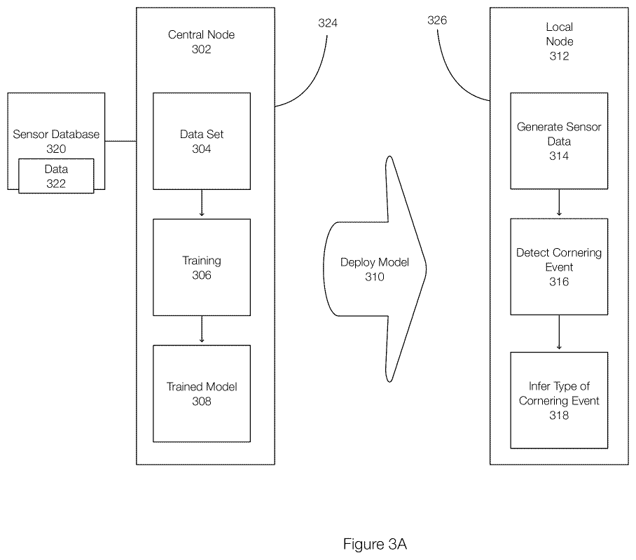

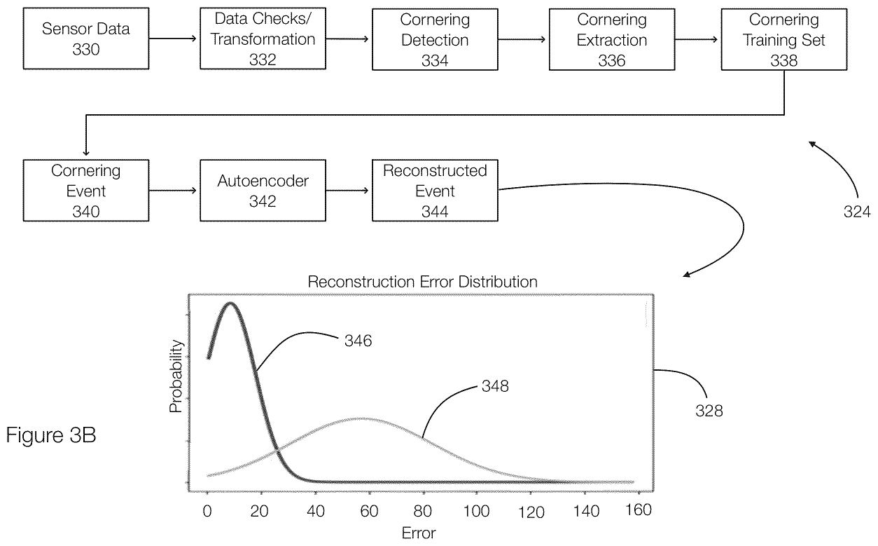

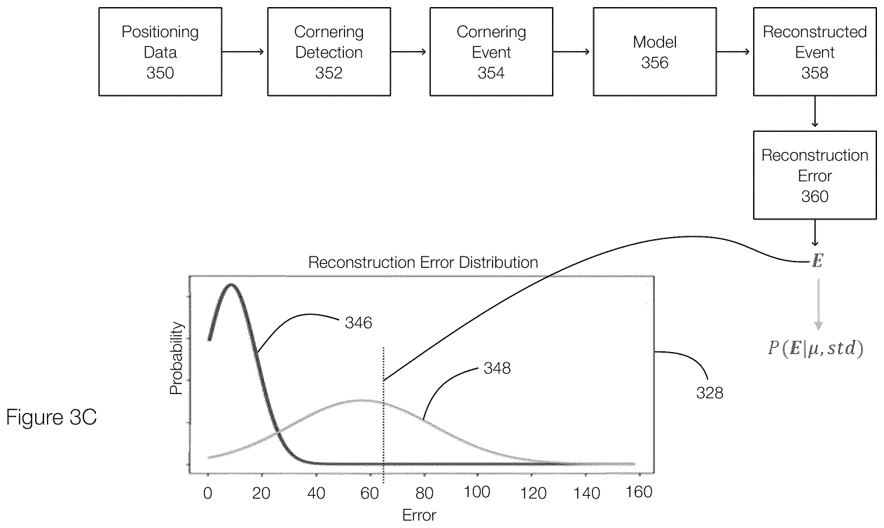

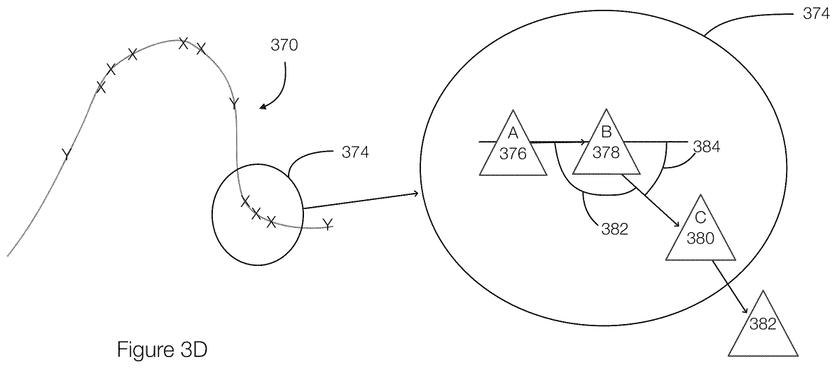

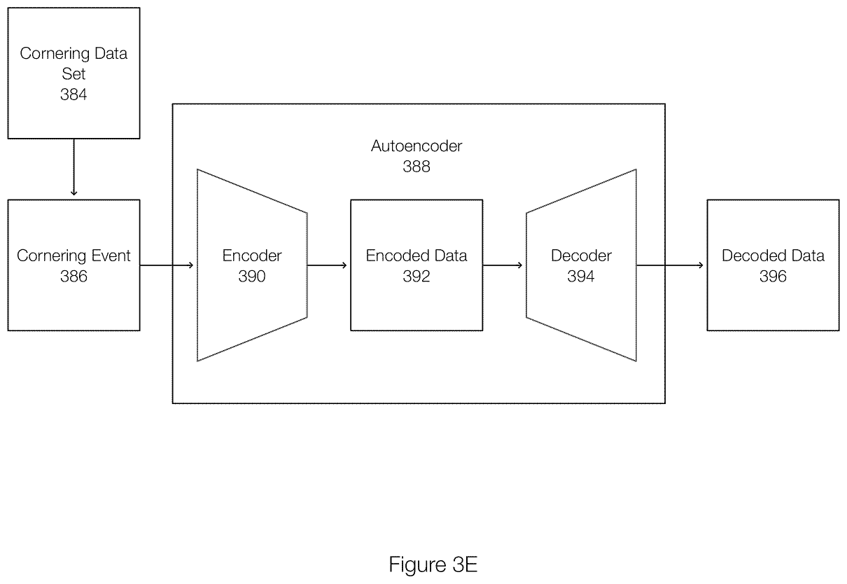

FIG. 3A discloses aspects of detecting cornering events including unsafe or dangerous cornering events. FIG. 3A, in effect, illustrates a training pipeline and an operational or inference pipeline. Generally, a model 308 is trained at the central node 302. Once the model 308 is trained, the model is deployed 310 to the local nodes, represented by the node 312.

More specifically, training the model 308 at the central node 302 is performed using a data set 304. As previously stated, the data set 304 may include positional data from multiple nodes operating in the environment. More specifically, the data set 304 may include, but is not limited to, positioning data, inertial data, and/or contextual data such as (for forklifts) fork height from the ground, weight of load carried by the forklift, and the like.

In one example, the data set 304 is a subset of the data 322 in the sensor database 320. More specifically, the data 322 in the sensor database 320 may be processed or analyzed to identify cornering data that is included in the data set 304. In one example, the data 322 (e.g., the collections) in the sensor database 320 may be processed in triplets in order to determine which of the triplets correspond to cornering data.

Prior to identifying positional data that corresponds to a cornering event, the sensor data 322 in the sensor database 320 may be checked to help ensure that the data 322 does not have errors and is ready for use as training data using hard checks and soft checks. A hard check ensures that the data 322 conforms to real-world specification. For example, data representing periods of non-movement (static data) can be discarded. Data with detectable high levels of noise that cannot be normalized can be discarded. Periods where GPS was not available or dropped out may also be discarded.

Soft checks detect whether nonconformant data is being considered and may attempt to correct some errors. For example, it may be necessary/beneficial to consider faulty positioning data. Soft checks may include amending “jumps” in the position data with a large space between two consecutive points (e.g., an interval larger than 100 meters), or time jumps where two consecutive points were collected with a gap in a time threshold (e.g., 10 seconds or more). In these cases, the data can be amended by segmentation into different distinct trajectories such that no cornering event can belong to two trajectories at the same time.

After checking the data, data transformation operations are performed. This includes capturing triplets of positioning data and composing or identifying cornering events from the triplets. In one example, cornering events may be identified from other combinations of number of data points. A cornering event can be associated with a specific position and/or with each triplet.

FIG. 3B discloses aspects of a training pipeline for training a model to determine or infer dangerous or non-normative events such as cornering events. In the pipeline 324, sensor data 330 is acquired. The sensor data 330 may include data from multiple nodes. To generate a cornering training set 338, the sensor data 330 is checked and transformed 332. The data checks and transformation can check for data availability, noise, and may include performing domain appropriate data segmentation. Known outliers may be filtered out during this process.

Once the sensor data 330 has been checked and/or transformed, cornering detection 334 is performed. In one example, cornering detection 334 captures triplets of positional data (both position and inertial). When cornering is detected, the relevant data is extracted 336 to generate the cornering training data set 338. The cornering training data set 338 may include cornering events, represented by the cornering event 340. The cornering event 340 is input to the autoencoder 342 to generate a reconstructed event 344. The autoencoder 342 (or machine learning model) can reconstruct the input cornering event.

The autoencoder 342 may be associated with a reconstruction error distribution 328. Typical or normative curves, based on the cornering training data set 338, are represented by the distribution 346. Anomalous curves may be represented by the distribution 348. Once the autoencoder 342 is trained, the autoencoder 342 may be deployed to the local nodes.

FIG. 3C discloses aspects of an inference pipeline 326 after the trained model has been deployed to the nodes. FIG. 3C illustrates an example of an inference pipeline operating at each of the nodes. In FIG. 3C, positioning data 350 (at least position and/or inertial data) is generated by sensors. The positioning data 350 is subject to cornering detection, which may include data checks and transformations. Cornering detection 352 may be performed repeatedly as the positioning data 350 is generated. When a cornering event is detected, the cornering event is input to the model 356, which generates a reconstructed event 358. The reconstructed event 358 is associated with a reconstruction error 360. The reconstruction error 360 can be compared to a threshold based on the parameters of the reconstruction error distribution 328 for the typical cornering events represented in the training data set. In this example, the reconstruction error may determine or represent a normal or a non-normal cornering event.

Alternatively, the output may be a normalized reconstruction score. The operation of the forklift can automate the movement (e.g., prevent the dangerous cornering event).

FIG. 3D discloses aspects of identifying cornering data from the sensor data in the sensor database or from sensor data generated at the local nodes. In FIG. 3D, a path 370 represents a path taken by a forklift in an environment. Each dot in the path 370 represent an instance of position data. Each “X” represents deceleration data, and each “Y” represents acceleration data.

This demonstrates how positional data (position and/or inertial data) is collected and correlated. In this example, the portion 374 of the path 370 is evaluated. More specifically, three positional data points or collections 376, 378 and 380 are evaluated together as a triplet. In one example, the positions 376, 378 and 380 (which may include position data, inertial data, and other data such as load data, mast position, or the like) are sequential in time. When analyzing the triplets, the next triplet analyzed may be the next set of 3 positions. Alternatively, the positions are evaluated in a manner such that the next triplet includes the positions 378, 380, and 382.

The triplet 374, using the position data, may for a situation with an interior angle 382 and an exterior angle 384. In one example, each data point may be associated with an internal angle 382 and an external angle 384.

If the positions 376, 378 and 380 are positions A, B, and C, the distances d_{AB} and d_{BC} and d_{AC} are known. The internal angle of the data point 378 (or the angle of P_{B} is given by the law of cosines:

$$β = {cos}^{- 1} ( \frac{{d}_{AB}^{2} + {d}_{BC}^{2} - {d}_{AC}^{2}}{2 {d}_{AB} {d}_{BC}} )$$

Once the internal angle 382 β for the position 378 (B) is determined, a cornering may be determined by comparing the internal angle 382 to a threshold. Positions that do not satisfy the threshold may be considered as straight lines and are not included as cornering events or in the cornering data set. By identifying positional data that corresponds to cornering events, returning to FIG. 3A, the positional data corresponding to cornering events are included in the data set 304 used to train the model 308.

Once the data set 304 is prepared, the model 308 is trained 306 with the data set 304. The data set may include triplets of data points, where each data point has features such as the information about acceleration (x, y and z axis), internal and external cornering angle, latitude, longitude, or the like.

FIG. 3E discloses aspects of a model configured to identify or infer non-normative cornering events. In one example, the trained model 308 is an autoencoder model, represented by the autoencoder 388. In one example the cornering data set 384 may be used to train the autoencoder 388. The autoencoder 388 is often unsupervised and learns to encode/decode data. For example, a cornering event 386 from the cornering data set 384 is input into the encoder 390. In effect, the encoder 390 may compress the cornering data event 386 (or the cornering data set 384) into compressed or encoded data 392. The decoder 394 operates to decompress or decode the encoded data 392. Ideally, the decoded data 396 is the same as the input data 386. Each datum Xᵢ (cornering event data) input into the encoder 390 generates a latent vector Zᵢ (encoded data 392) that, when passed through the decoder 394 generates a decompressed datum X′ᵢ (the decoded data 396). The encoder 390 may be represented as f_{θ}_{ₑ}(x) and the decoder 394 may be represented as f_{θ}_{_{d}}(z). In this formulation, θ represents or determines the parameterization where θₑ refers to the encoding parameters and θₑ refers to the decoding parameters.

Once the autoencoder 388 has been trained with the cornering data set 384, a reconstruction error (e.g., L1 loss) is determined for each sample in the training data set (e.g., the data 384). This can provide an error estimation for typical or normal cornering events, which were used to train the autoencoder model 388. Data corresponding to dangerous cornering events is not used to train the autoencoder such that dangerous or non-normative cornering events can be identified using the loss.

Returning to FIG. 3A, training (e.g., a training pipeline) 324 is performed at the central node 302. In this example data is collected from the objects (e.g., the nodes or forklifts). The data may include positioning data, inertial data, and contextual data. Cornering events are identified from the data to obtain a dataset of cornering events. Next, a model, such as an autoencoder model, is trained using the cornering events such that the autoencoder is capable of reconstructing the cornering events.

Next, a loss metric is obtained from every cornering event in the training data set (e.g., L1 loss). Once the loss metric is determined, descriptive statistics of typical cornering events based on the reconstruction error of the training dataset are obtained. This may include fitting a Gaussian distribution to the L1 losses of the training data, obtaining a mean (μ) and a standard deviation (σ) from the distribution.

A parameter z establishes a tolerance to error in reconstructing a cornering event. The parameter can be pre-defined or fined tuned from the training data. In one example, a threshold t that establishes a tolerance to error in the reconstruction of a cornering event. The threshold may be defined as t=μ+z*σ.

Because of the data checks performed on the data, the training data set is expected to include normative behavior such that dangerous cornering events are not considered as normal events by the model.

After the model 308 is trained, the model 308 is deployed 310 to a local node 312. An inference pipeline 326 may be implemented at the local node 312. Generally, sensor data is generated 314 at the local node 312. In effect, the data generated at the local node 312 is streamed or collected in real time at the local node 312. In one example, checks and transformations are applied to the data generated 314 at the local node 312. A cornering event 316 may be detected, for example, as previously described with respect to FIG. 3D.

When a cornering event 316 is detected, the corresponding data is input to the model, which infers 318 a type of cornering event. More specifically, the L1 loss for the data of the cornering event 316 input to the model is determined. If the loss L1 is greater than a normative reconstruction error threshold, the cornering event is determined or inferred to be a dangerous cornering event or determined to be non-normative, at least compared to the training data set 304.

The inference 318 is performed at the local nodes in the environment after the model and other information such as the mean and standard deviation of the training reconstruction error, are deployed to the local nodes.

An anomaly-detection approach to detect dangerous driving in real-time mobile entity operation is disclosed. Embodiments of the invention include detecting dangerous cornering events as anomalous in the dataset. This allows embodiments of the invention to be achieved in an unsupervised manner. The inference can be generated rapidly and allows real-time event detection. An empirical evaluation shows that the total time, in a reasonable computational environment, for the event detection, should typically be less than ˜100 ms.

Advantageously, event detection as disclosed herein is not dependent on dangerous cornering supervised data. As previously stated, an autoencoder neural network does not rely on supervised training in one embodiment and embodiments of the invention do not require labeled data.

The autoencoder can also be trained continuously as additional data is generated at the local nodes and provided to the central node. The autoencoder model is resilient to further training as new data is made available because the autoencoder does not suffer from the ‘catastrophic forgetting’ issue. Finally, the auto-encoder inference is fast and does not significantly contribute to the delay in decision making for the whole approach.

Embodiments of the invention further provide automation support. While actions such as alarms and notifications can be provided, embodiments of the invention can be used in the context of fully automated forklifts (or other automated objects or machines) at least because events can be detected within sub-second times, which is substantially real time, and allows actions to be taken immediately.

Embodiments of the invention detect cornering events from raw sensor data. Even given the practical restrictions imposed by (possibly) data unavailability and noise, any kind of positional data (GPS, WiFi or RFID triangulation, bearing sensor information, dead-reckoning approaches or combinations thereof) can be used. Similarly, embodiments can be adapted to leverage more or less fine-grained inertial measurements.

Advantageously, embodiments can be adapted to other domains. The model can be retrained using the data of those domains. When robust data checks are in place, embodiments of the invention can be as simple as applying the method (training and inferencing stages) to the new deployment.

Furthermore, autoencoder neural networks are much less likely to suffer from drastic concept drift, at least because autoencoder neural networks can be continuously and/or periodically trained with newly collected data. This fine-tuning of the model is not likely to be applicable to most machine learning domains due to the issue of catastrophic forgetting. This may not be a concern in embodiments of the invention as long as the new data adequately represents normative behavior. In this case, the autoencoder model's error for the training data can be used to compose the normative cornering event reconstruction threshold required for the real-time inference stage.

An empirical validation is provided as an appendix and is incorporated by reference in its entirety.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, logistic operations.

New and/or modified data collected and/or generated in connection with some embodiments, may be stored in an environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, containers, or VMs, or any combination of these, though no particular device implementation or configuration is required for any embodiment.

As used herein, the term ‘data’ is intended to be broad in scope. Thus, that term embraces, by way of example and not limitation, video data, sensor data, data segments such as may be produced by data stream segmentation processes, data chunks, data blocks, atomic data, or the like.

Example embodiments of the invention are applicable to any system capable of storing and handling various types of objects, in analog, digital, or other form. Although terms such as file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited. Each of the Figures may disclose aspects of structure and methods.

Following are some further example embodiments of the invention. These are presented only by way of example and are not intended to limit the scope of the invention in any way.

Embodiment 1. A method, comprising: detecting an event from sensor data at a node operating in an environment, inputting the event into a model configured to determine whether the event is non-normative, performing an action when the event is non-normative.

Embodiment 2. The method of embodiment 1, further comprising receiving positional data as the sensor data, wherein the positional data includes position data and inertial data, wherein the event is a cornering event and wherein only positional data corresponding to the cornering event is input into the model.

Embodiment 3. The method of embodiment 1 and/or 2, further comprising processing the sensor data to identify the data corresponding to cornering events including the cornering event.

Embodiment 4. The method of embodiment 1, 2, and/or 3, further comprising performing checks on the sensor data, the checks including determining that the sensor data corresponds to real world specifications, discarding data representing periods of non-movement, discarding data with high levels of noise that cannot be normalized, discarding data where position data is not available, and/or amending the positional data in selected instances where there is a gap in a time threshold of jumps in the position data.

Embodiment 5. The method of embodiment 1, 2, 3, and/or 4, further wherein the model is an autoencoder and non-normative events are detected based on a loss associated with the event input into the model.

Embodiment 6. The method of embodiment 1, 2, 3, 4, and/or 5, further comprising training the autoencoder with sensor data from multiple nodes including the node.

Embodiment 7. The method of embodiment 1, 2, 3, 4, 5, and/or 6, further comprising performing checks on the sensor data from the multiple nodes and identifying normative cornering data from the sensor data such that the autoencoder is trained using only the normative cornering data.

Embodiment 8. The method of embodiment 1, 2, 3, 4, 5, 6, and/or 7, wherein training the autoencoder with only the normative cornering data allows unsafe cornering events to be inferred based on a loss of the autoencoder.

Embodiment 9. The method of embodiment 1, 2, 3, 4, 5, 6, 7, and/or 8, wherein the loss is associated with a reconstruction error, wherein the event is a non-normative event when the reconstruction error exceeds a threshold defined by a mean, a standard deviation, and/or a tolerance parameter.

Embodiment 10. The method of embodiment 1, 2, 3, 4, 5, 6, 7, 8, and/or 9, wherein the model is configured to consider data triplets when determining whether the event is non-normative, wherein, the triplets are each associated with an internal angle and an external angle that determine whether the event is a cornering event.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

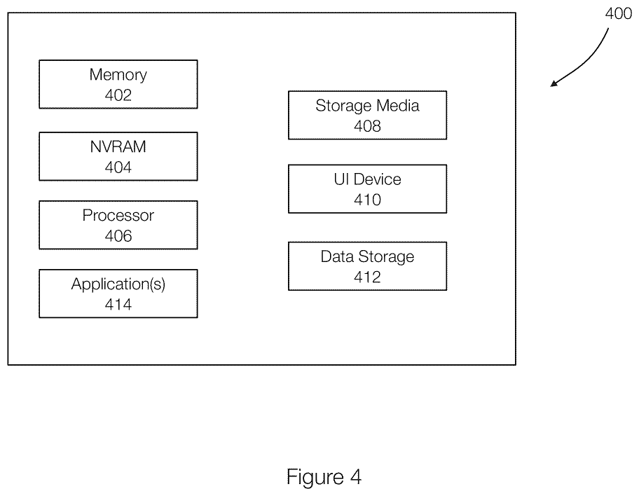

With reference briefly now to FIG. 4, any one or more of the entities disclosed, or implied, by Figures and/or elsewhere herein, may take the form of, or include, or be implemented on, or hosted by, a physical computing device, one example of which is denoted at 400. As well, where any of the aforementioned elements comprise or consist of a container or a virtual machine (VM), that VM may constitute a virtualization of any combination of the physical components disclosed in FIG. 4.

In the example of FIG. 4, the physical computing device 400 includes a memory 402 which may include one, some, or all, of random-access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid-state device (SSD) storage. As well, one or more applications 414 may be provided that comprise instructions executable by one or more hardware processors 406 to perform any of the operations, or portions thereof, disclosed herein. The device 400 may alternatively represent a computing system, a cloud or edge environment, a node, or the like or combination thereof.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
detecting an event from sensor data at a node operating in an environment;
inputting the event into a model configured to determine whether the event is non-normative;
performing an action when the event is non-normative.

2. The method of claim 1, further comprising receiving positional data as the sensor data, wherein the positional data includes position data and inertial data, wherein the event is a cornering event and wherein only positional data corresponding to the cornering event is input into the model.

3. The method of claim 2, further comprising processing the sensor data to identify the data corresponding to cornering events including the cornering event.

4. The method of claim 2, further comprising performing checks on the sensor data, the checks including determining that the sensor data corresponds to real world specifications, discarding data representing periods of non-movement, discarding data with high levels of noise that cannot be normalized, discarding data where position data is not available, and/or amending the positional data in selected instances where there is a gap in a time threshold of jumps in the position data.

5. The method of claim 1, further wherein the model is an autoencoder and non-normative events are detected based on a loss associated with the event input into the model.

6. The method of claim 5, further comprising training the autoencoder with sensor data from multiple nodes including the node.

7. The method of claim 6, further comprising performing checks on the sensor data from the multiple nodes and identifying normative cornering data from the sensor data such that the autoencoder is trained using only the normative cornering data.

8. The method of claim 7, wherein training the autoencoder with only the normative cornering data allows unsafe cornering events to be inferred based on a loss of the autoencoder.

9. The method of claim 8, wherein the loss is associated with a reconstruction error, wherein the event is a non-normative event when the reconstruction error exceeds a threshold defined by a mean, a standard deviation, and/or a tolerance parameter.

10. The method of claim 1, wherein the model is configured to consider data triplets when determining whether the event is non-normative, wherein, the triplets are each associated with an internal angle and an external angle that determine whether the event is a cornering event.

11. A non-transitory storage medium having stored therein instructions that are executable by one or more hardware processors to perform operations comprising:
detecting an event from sensor data at a node operating in an environment;
inputting the event into a model configured to determine whether the event is non-normative;
performing an action when the event is non-normative.

12. The non-transitory storage medium of claim 11, further comprising receiving positional data as the sensor data, wherein the positional data includes position data and inertial data, wherein the event is a cornering event and wherein only positional data corresponding to the cornering event is input into the model.

13. The non-transitory storage medium of claim 12, further comprising processing the sensor data to identify the data corresponding to cornering events including the cornering event.

14. The non-transitory storage medium of claim 12, further comprising performing checks on the sensor data, the checks including determining that the sensor data corresponds to real world specifications, discarding data representing periods of non-movement, discarding data with high levels of noise that cannot be normalized, discarding data where position data is not available, and/or amending the positional data in selected instances where there is a gap in a time threshold of jumps in the position data.

15. The non-transitory storage medium of claim 11, further wherein the model is an autoencoder and non-normative events are detected based on a loss associated with the event input into the model.

16. The non-transitory storage medium of claim 15, further comprising training the autoencoder with sensor data from multiple nodes including the node.

17. The non-transitory storage medium of claim 16, further comprising performing checks on the sensor data from the multiple nodes and identifying normative cornering data from the sensor data such that the autoencoder is trained using only the normative cornering data.

18. The non-transitory storage medium of claim 17, wherein training the autoencoder with only the normative cornering data allows unsafe cornering events to be inferred based on a loss of the autoencoder.

19. The non-transitory storage medium of claim 18, wherein the loss is associated with a reconstruction error, wherein the event is a non-normative event when the reconstruction error exceeds a threshold defined by a mean, a standard deviation, and/or a tolerance parameter.

20. The non-transitory storage medium of claim 11, wherein the model is configured to consider data triplets when determining whether the event is non-normative, wherein, the triplets are each associated with an internal angle and an external angle that determine whether the event is a cornering event.
